(19) United States
(12) Patent Application Publication
(10) Pub. No.: US 2025/0231616 A1
(43) Pub. Date: Jul. 17, 2025

(54) INFORMATION PROCESSING DEVICE, AND CONTROL METHOD

(71) Applicant: Mitsubishi Electric Corporation, Tokyo (JP)

(72) Inventors: Naoto IIJIMA, Tokyo (JP); Tomoharu AWANO, Tokyo (JP); Kaori HANDA, Tokyo (JP)

(73) Assignee: Mitsubishi Electric Corporation, Tokyo (JP)

(21) Appl. No.: 19/170,400

(22) Filed: Apr. 4, 2025

Related U.S. Application Data
(63) Continuation of application No. PCT/JP2022/044205, filed on Nov. 30, 2022.

(51) Int. Cl. G06F 3/01; G05D 1/222; G05D 101/15; G06F 3/16

(52) U.S. Cl. CPC G06F 3/011; G05D 1/222; G06F 3/16; G05D 2101/15

(57) ABSTRACT

An information processing device includes an acquisition unit that acquires biological information on an operator, robot information, information indicating a sound space region, a work judgment learned model, and a parameter determination learned model, a judgment unit that judges whether the operator is performing work via the robot or not by using the robot information and the work judgment learned model, an identification unit that identifies a concentration level of the operator by using at least one item of information out of the biological information and the robot information if the operator is performing work via the robot, a determination unit that determines a parameter by using the parameter determination learned model, and a control unit that performs signal processing on the sound signal based on the parameter and transmits a sound signal obtained by the signal processing to the output device.

### CROSS-REFERENCE TO RELATED APPLICATION

This application is a continuation application of International Application No. PCT/JP2022/044205 having an international filing date of Nov. 30, 2022.

### BACKGROUND OF THE INVENTION

### 1. Field of the Invention

The present disclosure relates to an information processing device, and a control method.

### 2. Description of the Related Art

There have been known technologies that allow an operator to operate a robot by remote control. The robot has a dummy head. Sound around the robot is inputted to the dummy head. The operator can hear the sound around the robot via the dummy head. Here, a technology regarding the dummy head has been proposed (see Patent Reference 1).
Patent Reference 1: Japanese Patent Application Publication No. 62-044384

As described above, the operator is provided with the sound around the robot. The sound around the robot includes noise. For example, when the robot is installed in a factory, the sound around the robot includes noise in the factory. The noise is sound unnecessary to the operator. Unnecessary sound provided to the operator lowers working efficiency of the operator.

### SUMMARY OF THE INVENTION

An object of the present disclosure is to raise the working efficiency of the operator.

An information processing device according to an aspect of the present disclosure is provided. The information processing device executes communication with an output device that provides sound to an operator capable of operating a robot by remote control. The information processing device includes an acquisition unit that acquires biological information on the operator, robot information including a sound signal indicating sound around the robot, information indicating a sound space region as a sound space in which the operator is hearing sound via the output device, a work judgment learned model, and a parameter determination learned model, a judgment unit that judges whether the operator is performing work via the robot or not by using the robot information and the work judgment learned model, an identification unit that identifies a concentration level of the operator by using at least one item of information out of the biological information and the robot information if the operator is performing work via the robot, a determination unit that determines a parameter, for providing the operator with a sound space corresponding to the sound space region and the concentration level, by using the parameter determination learned model, and a control unit that performs signal processing on the sound signal based on the parameter and transmits a sound signal obtained by the signal processing to the output device.

According to the present disclosure, the working efficiency of the operator can be raised.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing a control system;

FIG. 2 is a diagram showing hardware included in an information processing device;

FIG. 3 is a block diagram showing functions of the information processing device;

FIG. 4 is a graph showing an example of a correspondence relationship between a concentration level and working hours;

FIG. 5 is a diagram showing an example of a direction in which sound is audible;

FIG. 6 is a diagram showing an example of a case where a sound space region is represented two-dimensionally;

FIG. 7 is a diagram for explaining reinforcement learning;

FIG. 8 is a diagram for explaining supervised learning;

FIG. 9 is a diagram showing an example of a rulebase; and

FIG. 10 is a flowchart showing an example of a process executed by the information processing device.

### DETAILED DESCRIPTION OF THE INVENTION

An embodiment will be described below with reference to the drawings. The following embodiment is just an example and a variety of modifications are possible within the scope of the present disclosure.

### Embodiment

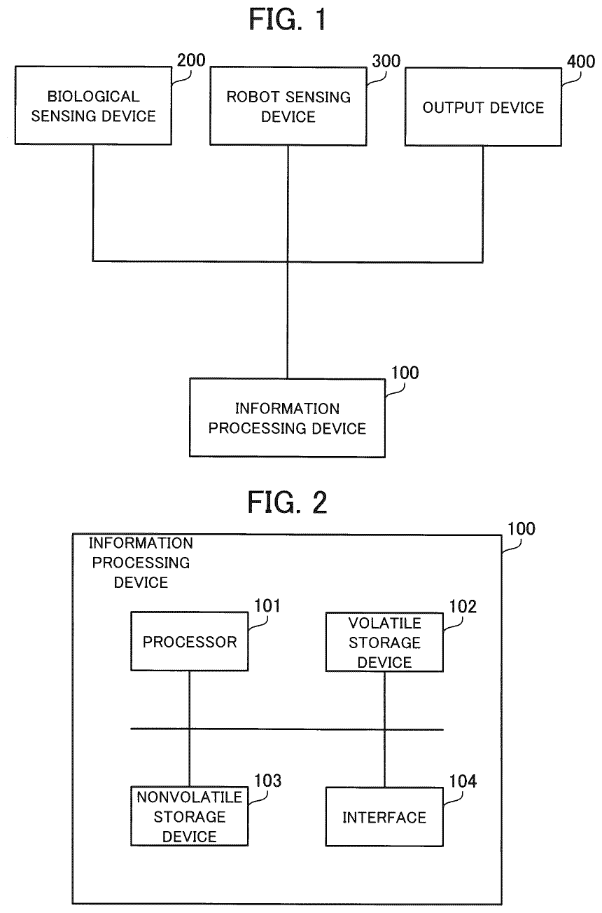

FIG. 1 is a diagram showing a control system. The control system includes an information processing device 100, a biological sensing device 200, a robot sensing device 300 and an output device 400.

The information processing device 100, the biological sensing device 200, the robot sensing device 300 and the output device 400 execute communication via a network. The network is a wired network or a wireless network.

In the control system, an operator is capable of operating a robot by remote control.

The information processing device 100 is a device that executes a control method.

The biological sensing device 200 measures biological information on the operator. For example, the biological information is information regarding a sensory organ or a locomotive organ. For example, the information regarding a sensory organ is information regarding eyes, facial expression, the heart rate, brain waves, or the like. Specifically, the information regarding eyes is the direction of the line of sight, the degree (width) of opening the eyes, the shape of each pupil, the number of times of blinking per unit time, or the like. The information regarding the eyes and the facial expression can be acquired from a camera. The heart rate can be acquired from a measuring instrument of the wristband type. The brain waves can be acquired from a brain wave sensor attached to the user's head. Further, for example, the information regarding a locomotive organ is information regarding movement of skeletal structure of the operator, movement of the head, or the like. The movement of the skeletal structure can be acquired from a camera. The movement of the head can be acquired from a sensor attached to the user's head.

The robot sensing device 300 acquires robot information including environment information. The environment information is information regarding environment around the robot. For example, the environment information is an image or a video indicating the environment around the robot. Further, for example, the environment information is a sound signal indicating sound around the robot. The image or the video can be acquired from a camera mounted on the robot. The sound signal can be acquired from a multichannel microphone mounted on the robot. The robot information may include robot position information and robot movement information. The robot position information is information indicating the position of the robot. For example, the robot position information can be acquired from a Global Positioning System (GPS) mounted on the robot. The robot movement information is information indicating movement of the robot. The robot movement information may be acquired from information inputted to a controller by the operator.

The output device 400 is a speaker, a headphone or the like, for example. The output device 400 provides sound to the operator.

Next, hardware included in the information processing device 100 will be described below.

FIG. 2 is a diagram showing the hardware included in the information processing device. The information processing device 100 includes a processor 101, a volatile storage device 102, a nonvolatile storage device 103 and an interface 104.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include processing circuitry.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

The interface 104 executes communication with the biological sensing device 200, the robot sensing device 300 and the output device 400.

Next, functions of the information processing device 100 will be described below.

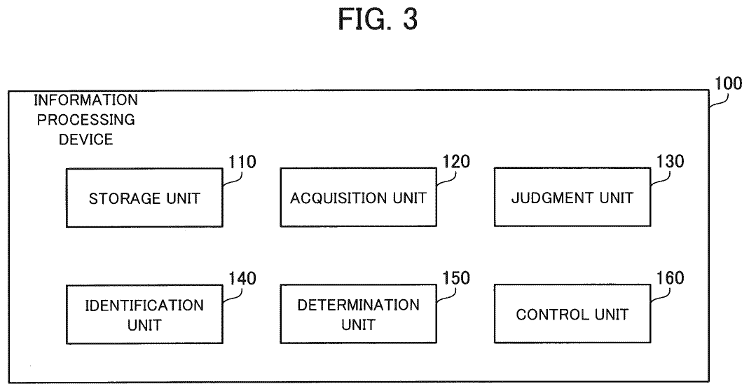

FIG. 3 is a block diagram showing the functions of the information processing device. The information processing device 100 includes a storage unit 110, an acquisition unit 120, a judgment unit 130, an identification unit 140, a determination unit 150 and a control unit 160.

The storage unit 110 may be implemented as a storage area reserved in the volatile storage device 102 or the nonvolatile storage device 103.

Part or all of the acquisition unit 120, the judgment unit 130, the identification unit 140, the determination unit 150 and the control unit 160 may be implemented by processing circuitry. Further, part or all of the acquisition unit 120, the judgment unit 130, the identification unit 140, the determination unit 150 and the control unit 160 may be implemented as modules of a program executed by the processor 101. For example, the program executed by the processor 101 is referred to also as a control program. The control program has been recorded in a record medium, for example.

The storage unit 110 stores a variety of information.

The acquisition unit 120 acquires the biological information on the operator from the biological sensing device 200. The acquisition unit 120 acquires the robot information from the robot sensing device 300. The acquisition unit 120 may acquire the biological information and the robot information via a different device.

The acquisition unit 120 may store the biological information and the robot information in the storage unit 110 each time the biological information and the robot information are acquired. By this, the biological information and the robot information are accumulated in the storage unit 110.

The acquisition unit 120 acquires information indicating a sound space region. The sound space region is a sound space in which the operator is hearing sound via the output device 400. Simply put, the sound space region is a sound space in which the operator is currently hearing sound. Details of the sound space region will be described later. Incidentally, the acquisition unit 120 acquires the information indicating the sound space region from the storage unit 110 or an external device. The external device is a device connectable to the information processing device 100. The external device is a cloud server, for example. Incidentally, illustration of the external device is left out.

Further, the acquisition unit 120 acquires a work judgment learned model. For example, the acquisition unit 120 acquires the work judgment learned model from the storage unit 110. Alternatively, for example, the acquisition unit 120 acquires the work judgment learned model from the external device.

The judgment unit 130 judges whether the operator is performing work via the robot or not by using the robot information and the work judgment learned model. In other words, the judgment unit 130 judges whether the operator is operating the robot by remote control or not by using the robot information and the work judgment learned model. It can also be expressed that the judgment unit 130 judges whether the operator is performing particular work via the robot or not by using the robot information and the work judgment learned model. For example, when the judgment unit 130 inputs the robot information to the work judgment learned model, the work judgment learned model outputs information indicating whether or not the operator is performing work via the robot. The judgment unit 130 judges whether the operator is performing work via the robot or not based on the information. Incidentally, for example, the work judgment learned model estimates whether the operator is performing work via the robot or not based on the sound signal included in the robot information. Further, for example, the work judgment learned model estimates whether the operator is performing work via the robot or not based on the robot movement information included in the robot information.

If the operator is performing work via the robot, the identification unit 140 identifies a concentration level of the operator by using at least one item of information out of the biological information and the robot information.

A method of identifying the concentration level will be described below. The identification unit 140 identifies the concentration level by using the acquired biological information. For example, the identification unit 140 identifies the concentration level corresponding to the acquired biological information by using a table indicating a correspondence relationship between the biological information and the concentration level. Further, for example, a learned model may output the concentration level when the identification unit 140 inputs the acquired biological information to the learned model.

The identification unit 140 may identify the concentration level of the operator by using the acquired biological information (i.e., present biological information) and biological information acquired in the past.

Further, the identification unit 140 may identify the concentration level of the operator by using the acquired biological information, the acquired robot information (i.e., present robot information), robot information acquired in the past, and a learned model. Here, the reason for using the robot information will be described below. There is a relationship between the movement of the robot indicated by the robot movement information included in the robot information and the concentration level. When the robot is moving efficiently, the concentration level of the operator can be considered to be high. In contrast, when the robot is moving awkwardly (i.e., moving inefficiently), the concentration level of the operator can be considered to be low. As above, there is a relationship between the movement of the robot and the concentration level. Thus, by using the robot information as one element for identifying the concentration level, the concentration level with high accuracy can be obtained.

Furthermore, the identification unit 140 may identify the concentration level of the operator based on the operator's working hours obtained from the acquired robot information and robot information acquired in the past. In the identification of the concentration level, a learned model may be used. For example, when the identification unit 140 inputs the working hours to the learned model, the learned model outputs the concentration level. For example, the learned model is obtained by learning information indicating a correspondence relationship between the concentration level and the working hours. Here, an example of the correspondence relationship between the concentration level and the working hours will be shown below.

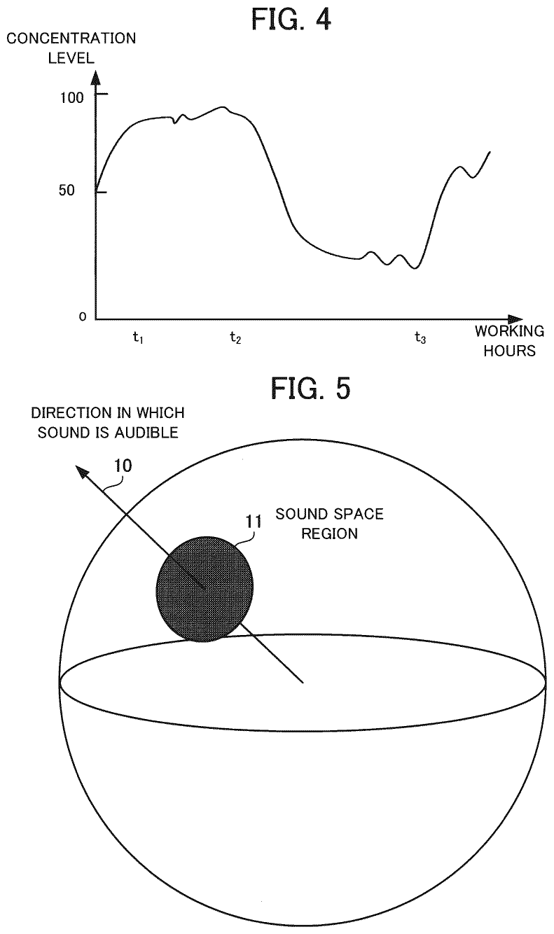

FIG. 4 is a graph showing an example of the correspondence relationship between the concentration level and the working hours. The vertical axis in FIG. 4 represents the concentration level. The horizontal axis in FIG. 4 represents the working hours. The learned model is obtained by learning of learning data like those indicated by the graph.

Further, in the identification of the concentration level, it is possible to use a table with which the concentration level can be identified.

Moreover, the identification unit 140 may identify the concentration level of the operator based on work type and the operator's working hours obtained from the acquired robot information and robot information acquired in the past. In the identification of the concentration level, it is possible to use a learned model or a table with which the concentration level can be identified.

Incidentally, when the identification unit 140 uses a learned model, the learned model is acquired by the acquisition unit 120. For example, the acquisition unit 120 acquires the learned model from the storage unit 110 or the external device. This learned model is referred to also as a concentration level identification learned model.

The determination unit 150 determines a parameter, for providing the operator with a sound space corresponding to the sound space region and the concentration level, by using a parameter determination learned model. This sentence can also be expressed as follows. The determination unit 150 determines a parameter, for providing a sound space for raising the working efficiency of the operator, by using the sound space region, the concentration level and the parameter determination learned model.

Specifically, when the determination unit 150 inputs the sound space region and the concentration level to the parameter determination learned model, the parameter determination learned model outputs the parameter. Incidentally, the parameter determination learned model and the sound space region will be described later.

Here, a direction in which sound is audible can be represented as in the following diagram.

FIG. 5 is a diagram showing an example of the direction in which sound is audible. FIG. 5 shows a case where the direction in which sound is audible is represented on a spherical surface. In FIG. 5, the direction in which sound is audible is indicated by an arrow 10. Further, FIG. 5 indicates a sound space region 11.

Further, a case where the sound space region is represented two-dimensionally will be shown below.

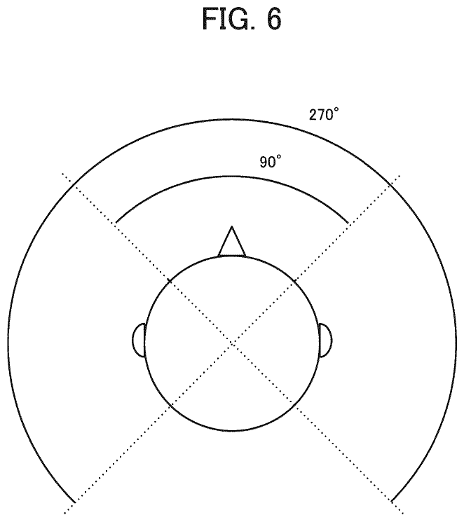

FIG. 6 is a diagram showing an example of the case where the sound space region is represented two-dimensionally. In FIG. 6, the sound space region is represented by an angle. In FIG. 6, the sound space region is represented by 90 degrees or 270 degrees, for example. Incidentally, the reference of the angle may be set at a front direction of the operator. For the simplicity of the explanation, the sound space region in the following description is assumed to be represented two-dimensionally.

Next, the parameter determination learned model will be described below. The parameter determination learned model is acquired by the acquisition unit 120. For example, the acquisition unit 120 acquires the parameter determination learned model from the storage unit 110 or the external device. The parameter determination learned model can be obtained by machine learning. For example, the parameter determination learned model can be obtained by reinforcement learning. The reinforcement learning will be explained below by using a diagram.

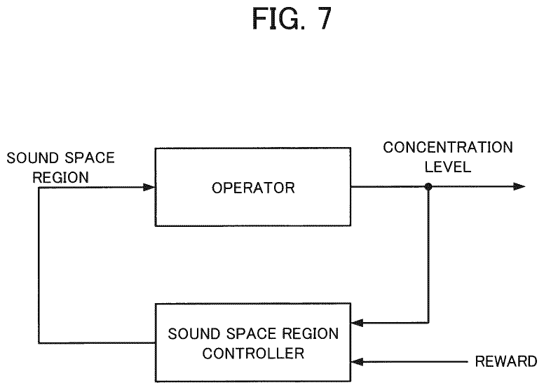

FIG. 7 is a diagram for explaining the reinforcement learning. An environment part in the reinforcement learning corresponds to the concentration level of the operator. An agent in the reinforcement learning corresponds to a sound space region controller.

For example, when the operator is made to maintain a state at a high concentration level, a reward function is designed so that a high reward can be obtained for an action at a high concentration level. Then, an optimum strategy is learned.

The parameter determination learned model may also be obtained by a learning method other than the reinforcement learning. For example, the parameter determination learned model can be obtained by supervised learning. The supervised learning will be explained below by using a diagram.

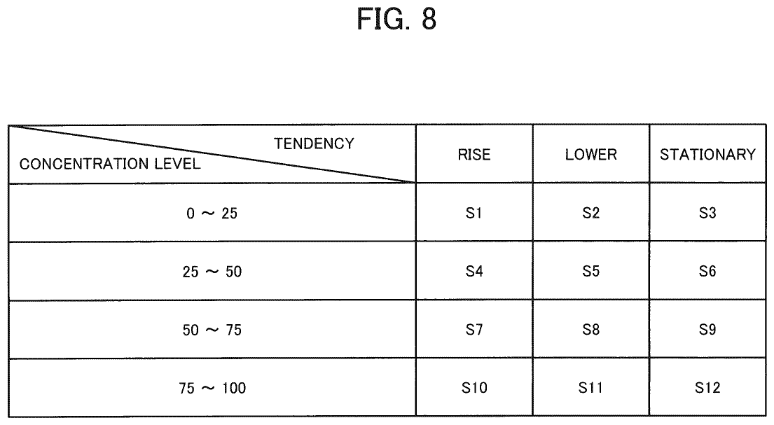

FIG. 8 is a diagram for explaining the supervised learning. Twelve types of states, each indicating a relationship between the concentration level of the operator and a tendency in a constant time, are generated. The twelve types of states can be represented also as states of the operator. In the machine learning, the concentration level of the operator in a constant time is used as input data. Further, in the machine learning, the states of the operator are used as correct answer labels. The parameter is determined based on the state of the operator by using a rulebase. An example of the rulebase will be shown below.

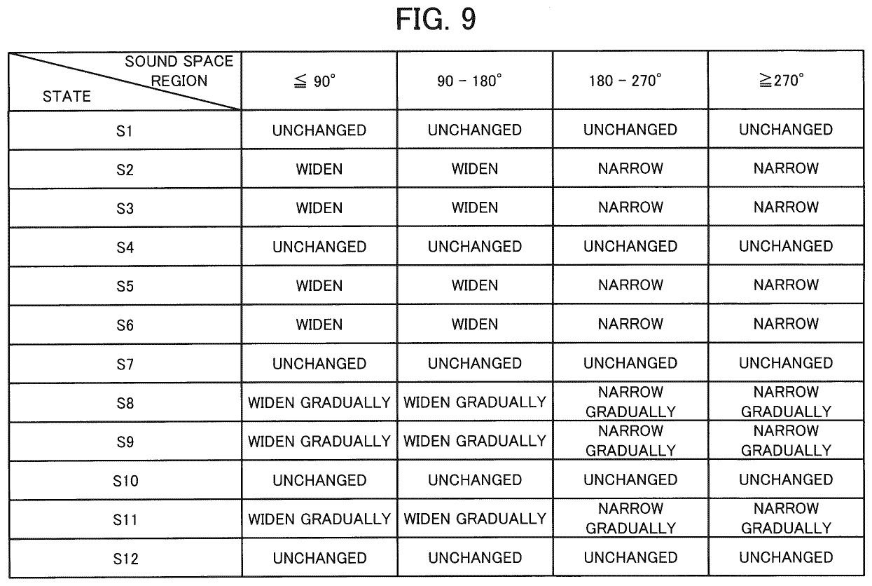

FIG. 9 is a diagram showing an example of the rulebase. For example, when the state of the operator is “S2” and the sound space region is less than or equal to 90 degrees, a parameter for widening the sound space region is outputted.

Further, supervised learning described below may be executed. Time-series data of the parameter is used as input data. Then, in the machine learning, the learning is executed so that a parameter that is expected to raise the concentration level the most is outputted.

As above, the parameter determination learned model is obtained by the learning.

Here, a method of determining the parameter will be described below by using concrete examples.

For example, when the present sound space region is wide (e.g., 270 degrees) and the concentration level is low, the determination unit 150 determines a parameter for narrowing the sound space region in order to raise the concentration level of the operator. For example, the determination unit 150 determines a parameter for narrowing the sound space region from 270 degrees to 90 degrees.

Further, for example, when the present sound space region is narrow (e.g., 90 degrees) and the concentration level is low, it can be considered that the operator is fatigued with hyperfocusing. Therefore, the determination unit 150 determines a parameter for widening the sound space region in order to let the operator relax. For example, the determination unit 150 determines a parameter for widening the sound space region from 90 degrees to 270 degrees.

The control unit 160 performs signal processing on the sound signal included in the robot information based on the determined parameter. For example, the signal processing is beamforming processing, sound masking processing or the like. By this signal processing, the sound signal is converted to a sound signal corresponding to the parameter.

The control unit 160 transmits the sound signal obtained by the signal processing to the output device 400. By this, for example, the operator being provided with sound with a wide sound space region and being at a low concentration level can hear sound whose sound space region has been narrowed. Accordingly, the concentration level of the operator rises and thus the working efficiency of the operator rises. Further, for example, the operator being provided with sound with a narrow sound space region and being at a low concentration level can hear sound whose sound space region has been widened. Accordingly, the operator is relaxed and thus the working efficiency of the operator rises.

Next, a process executed by the information processing device 100 will be described below by using a flowchart.

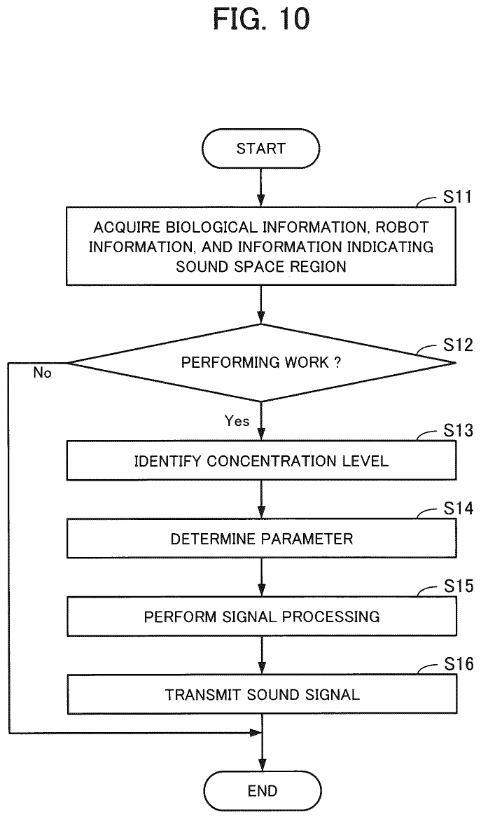

FIG. 10 is a flowchart showing an example of the process executed by the information processing device.

(Step S11) The acquisition unit 120 acquires the biological information, the robot information, and the information indicating the present sound space region.

(Step S12) The judgment unit 130 judges whether the operator is performing work via the robot or not by using the robot information and the work judgment learned model. If the operator is performing work, the process advances to step S13. If the operator is not performing work, the process ends.

(Step S13) The identification unit 140 identifies the concentration level of the operator by using the biological information and the robot information.

(Step S14) The determination unit 150 determines the parameter, for providing the operator with the sound space corresponding to the sound space region and the concentration level, by using the parameter determination learned model.

(Step S15) The control unit 160 performs the signal processing on the sound signal included in the robot information based on the determined parameter.

(Step S16) The control unit 160 transmits the sound signal obtained by the signal processing to the output device 400.

According to the embodiment, the information processing device 100 determines the parameter for providing a sound space for raising the working efficiency of the operator. The information processing device 100 performs the signal processing on the sound signal based on the determined parameter. The information processing device 100 provides the sound signal obtained by the signal processing to the operator via the output device 400. Accordingly, the information processing device 100 is capable of raising the working efficiency of the operator.

### DESCRIPTION OF REFERENCE CHARACTERS

10: arrow, 11: sound space region, 100: information processing device, 101: processor, 102: volatile storage device, 103: nonvolatile storage device, 104: interface, 110: storage unit, 120: acquisition unit, 130: judgment unit, 140: identification unit, 150: determination unit, 160: control unit, 200: biological sensing device, 300: robot sensing device, 400: output device

What is claimed is:

1. An information processing device that executes communication with an output device that provides sound to an operator capable of operating a robot by remote control, the information processing device comprising:
acquiring circuitry to acquire biological information on the operator, robot information including a sound signal indicating sound around the robot, information indicating a sound space region as a sound space in which the operator is hearing sound via the output device, a work judgment learned model, and a parameter determination learned model;
judging circuitry to judge whether the operator is performing work via the robot or not by using the robot information and the work judgment learned model;
identifying circuitry to identify a concentration level of the operator by using at least one item of information out of the biological information and the robot information if the operator is performing work via the robot;
determining circuitry to determine a parameter, for providing the operator with a sound space corresponding to the sound space region and the concentration level, by using the parameter determination learned model; and
controlling circuitry to perform signal processing on the sound signal based on the parameter and transmit a sound signal obtained by the signal processing to the output device.

2. The information processing device according to claim 1, wherein the identifying circuitry identifies the concentration level of the operator by using the acquired biological information and biological information acquired previously if the operator is performing work via the robot.

3. The information processing device according to claim 1, wherein
the robot information includes robot movement information as information regarding movement of the robot,
the acquiring circuitry acquires a concentration level identification learned model, and
the identifying circuitry identifies the concentration level of the operator by using the biological information, the acquired robot information, robot information acquired previously, and the concentration level identification learned model if the operator is performing work via the robot.

4. The information processing device according to claim 1, wherein the identifying circuitry identifies the concentration level of the operator based on the operator's working hours obtained from the acquired robot information and robot information acquired previously if the operator is performing work via the robot.

5. The information processing device according to claim 4, wherein the identifying circuitry identifies the concentration level of the operator based on work type and the operator's working hours obtained from the acquired robot information and robot information acquired previously if the operator is performing work via the robot.

6. A control method performed by an information processing device that executes communication with an output device which provides sound to an operator capable of operating a robot by remote control, the control method comprising:
acquiring biological information on the operator, robot information including a sound signal indicating sound around the robot, information indicating a sound space region as a sound space in which the operator is hearing sound via the output device, a work judgment learned model, and a parameter determination learned model, judging whether the operator is performing work via the robot or not by using the robot information and the work judgment learned model, identifying a concentration level of the operator by using at least one item of information out of the biological information and the robot information if the operator is performing work via the robot, determining a parameter, for providing the operator with a sound space corresponding to the sound space region and the concentration level, by using the parameter determination learned model;
performing signal processing on the sound signal based on the parameter; and
transmitting a sound signal obtained by the signal processing to the output device.

7. An information processing device, executing communication with an output device that provides sound to an operator capable of operating a robot by remote control, the information processing device comprising:
a processor to execute a program; and
a memory to store the program which, when executed by the processor, performs processes of,
acquiring biological information on the operator, robot information including a sound signal indicating sound around the robot, information indicating a sound space region as a sound space in which the operator is hearing sound via the output device, a work judgment learned model, and a parameter determination learned model, judging whether the operator is performing work via the robot or not by using the robot information and the work judgment learned model, identifying a concentration level of the operator by using at least one item of information out of the biological information and the robot information if the operator is performing work via the robot, determining a parameter, for providing the operator with a sound space corresponding to the sound space region and the concentration level, by using the parameter determination learned model,
performing signal processing on the sound signal based on the parameter, and
transmitting a sound signal obtained by the signal processing to the output device.
